(19) United States
(12) Patent Application Publication
(10) Pub. No.: US 2019/0054634 A1
(43) Pub. Date: Feb. 21, 2019

(54) EFFECTOR UNIT FOR A ROBOT, WORK IMPLEMENT COMPRISING A ROBOT, AND METHOD FOR REPLACING AN EFFECTOR IN ROBOTS

(71) Applicant: KASTANIENBAUM GMBH, München (DE)

(72) Inventor: Sami Haddadin, Hannover (DE)

(73) Assignee: KASTANIENBAUM GMBH, München (DE)

(21) Appl. No.: 16/077,705

(22) PCT Filed: Feb. 15, 2017
(86) PCT No.: PCT/EP2017/053442

§ 371 Date: Aug. 13, 2018

(30) Foreign Application Priority Data
Feb. 15, 2016 (DE) 10 2016 001 627.2
Apr. 9, 2016 (DE) 10 2016 004 087.4

(51) Int. Cl. B25J 15/04; F16B 2/18

(52) U.S. Cl. CPC B25J 15/0433; F16B 2/185; B25J 15/0491; B25J 15/0475

(57) ABSTRACT

This invention concerns an effector unit (1) for a robot, which can be locked and unlocked via a relative movement of the robot, so that several effectors (3) can be used in the effector unit (1). In addition, the invention concerns a corresponding method for automatically changing effectors.

This invention relates to an effector unit for a robot, a working device or station with a robot and with an effector, and a method for changing an effector on a robot.

Effector units in robots consist of a supporting element which can be arranged on an end element of a manipulator or a robot arm of, for example, a programmable multi-axis robot, and an effector, which supporting element and effector can be connected to one another by means of a coupling device.

Coupling devices in the field of robotics are known in a wide variety of designs and are used to provide automation when changing various effectors or tools. In industrial robots, such tool changers are equipped with robot-side and tool-side coupling elements, which interlock positively and are connected to one another by a locking mechanism in a lossless and force-transmitting but detachable manner, whereby the locking mechanism has its own drive, which can be integrated in the tool changer. Examples of such coupling principles are shown in WO 99/19121 A1, which concerns a changeover clutch with locking elements in the form of balls, or in DE 202 08 060 U1, which discloses a locking mechanism in the form of a locking ring with radially arranged, electromechanically driven claw elements.

It is also known to connect interlocking coupling elements by means of an electromagnetic lock, as been taught by DE 10 2005 052 627 A1. Moreover, from DE 10 2007 030 035 A1 a gripper tool with a finger change system is known in which the gripper fingers can be locked by means of an expandable body, i.e. in a pneumatic manner.

Spring-loaded coupling or detent elements for tool changers are known from JP 2011/189415, JP 2010/120140 or DE 20 2011 052 430 U1, for example.

The coupling technology described above is preferably used with programmable industrial robots that have position-controlled axes and are generally designed for correspondingly high lifting capacities. For position control, the external forces acting on the industrial robot must be measured, which form the basis for the desired dynamic behavior, which is then transmitted to the robot via inverse kinematics, also known as admittance control.

Of course, the programming effort for such industrial robots to implement the use of tool changing systems or effector units using several different effectors is very high. The position control must be highly precise so that the individual robot-side and tool- or effector-side coupling elements, in addition to any existing medium couplings, can fit precisely into one another due to the positive fit to be realized. Due to the control principle used, these robots are therefore not able to detect errors or deviations, for example if for some reason the robot-side coupling element is not exactly aligned with the tool-side coupling element, and to react accordingly.

A perfect change of effectors is therefore only possible if the effectors are deposited exactly in the position specified by the programming, for example in a holding device arranged stationary in the working area of the robot. Even the use of a tool magazine with several interchangeable, possibly different tools or effectors considerably increases the programming effort and thus the susceptibility to errors.

Basically, the coupling mechanisms known from the state of the art described above are characterized by partly very complex mechanics. The necessity of normally electromechanically operated drives to activate the various locking elements requires its own control and power supply, which inevitably increases the susceptibility to errors. In addition, the coupling elements have a high dead weight due to their design.

Based on this, one of the objects of this invention is to provide an improved coupling technology for robots. In particular, it is an object of the present invention to provide a tool changing system or a corresponding working device for robot systems, as preferred for robots of the lightweight construction type.

These objects are solved with an effector unit with the features according to claim 1 and with a working device with a robot and with such an effector unit with the features according to claim 19. In this context, the invention also proposes a method for changing a tool element or an effector at an end member of a robot with the features according to claim 25.

One aspect of the invention relates to an effector unit for a robot with a supporting (or holding or retaining) element arranged at one end member of the robot, with an effector which can be fastened to the supporting element by means of coupling elements engaging in a positive and/or non-positive manner, and with a locking mechanism which detachably and captively connects a coupling element of the effector to a coupling element of the supporting element. The supporting element in the meaning of the invention thus serves the releasable reception of an effector independent of its actual design and functional determination.

According to the invention, the supporting element is designed to be movable relative to the end link or member of the robot arm. The coupling elements of both the supporting element and the effector can be connected in a common axial alignment which is arranged parallel to the direction of movement of the supporting element.

As a result of a coupling of the supporting element with the effector, any direction of actuation of the effector can be aligned with the direction of movement of the supporting element assigned to it.

Preferably, a parallel gripping mechanism is provided on the end link or member, which is formed by two supporting elements which can move linearly towards or away from each other, whereby the linear infeed determines the direction of movement.

As a rule, the effector carrier or supporting element can have a longitudinal extension which should essentially run in the direction of a translatory direction of movement of the end member of the manipulator.

According to the invention, the coupling elements should be designed and constructed in such a way that they can be connected or again decoupled by means of a rotary displacement movement of the robot, which, for example, leads to a pivoting movement of the supporting element, and/or a translatory displacement movement of the robot, which, for example, leads to a translatory movement of the supporting element in the direction of its longitudinal extension or to a translatory movement of the supporting element transversely to its longitudinal extension or combinations thereof.

In the context of the invention, effector means in principle every element by means of which the robot interacts with its environment. This includes all types of tool elements, such as screw heads for mounting objects, spray guns for painting, soldering irons for making electrical contacts, laser optics, cameras and the like, which are coupled directly to the supporting element.

In a preferred design of the invention, the effectors can be designed as simple gripper fingers or jaws for gripping any objects.

In this way it becomes possible for the robot, especially if it is equipped with an integrated compliance control, to assemble for itself gripper fingers with different designs and contours of the gripper surfaces for the respective application. Thus, according to the invention, the functionality of the effector unit goes beyond pure “pick & place” activities for which simple gripper fingers are sufficient; the effector can also generally function as a gripping mechanism capable of gripping any kind of tools, especially commercial manually actuated or normally hand-held power tools, such as a drill, either directly via suitably designed gripper fingers or jaws, or indirectly via tool holders which carry the tools and are gripped by the gripper effectors. Different effectors therefore serve as adapters for the different objects to be gripped.

According to the invention, the locking mechanism is arranged on the supporting element in such a way that it is freely accessible to an external actuating element and is also designed and constructed in such a way that it can be actuated by this external actuating element in an active or passive manner.

According to the invention, an external actuating element is an active or passive actuating element which is not part of the robot or the effector unit. Actuators that interact with the locking mechanism to lock the coupling elements, such as pneumatically or electrically driven pressure plungers, can be used as active actuating elements. Passive actuating elements include e.g. stationary abutments of any design.

According to a preferred embodiment of the invention, the locking mechanism should be designed and constructed in such a way that it can be actuated by a displacement movement of the robot under contact with such an abutment. The abutment can be located in the immediate area of a workspace associated with the robot within which the robot operates; for example, it can simply be a table edge or part of a machine housing in the area of a robot workstation against which the locking mechanism is guided by a corresponding movement of the robot.

In addition, the abutment can also be an element with which the locking mechanism can enter into a releasable engagement in order to release it again.

The effector unit serves for itself as a detachable connection between the effector or the tool element or gripper element and the supporting element serving as a receiving base therefor, which is detachably attachable to or inseparably connected to the end member of the robot, however, the supporting element being mounted movably relative to the end member via a corresponding drive or actuating mechanism. The end member with the at least one supporting element without the effector to be accommodated by it forms the distal end of a robot arm, preferably of a multi-axis robot arm of the lightweight construction type.

The effector unit according to the invention thus forms an independent universal coupling device which, in the sense of variable functionality, enables the robot to be adapted to different applications by selectively accommodating various effectors.

In one design, the coupling element of the supporting element can be designed as an opening to receive the coupling element of the effector with an opening width that can be varied by the locking mechanism. The locking mechanism shall be designed in such a way that, when actuated actively or passively by the external actuating element, it narrows the opening, which in principle has a shape which serves to accommodate a correspondingly shape-complementary coupling element of the effector, in order to clamp this coupling element in a captive manner.

Preferably the opening is a substantially circular recess and the coupling element of the effector is a correspondingly cylindrical pin, which can then be clamped in the opening in a captive and rotationally secure manner. However, other geometries are also conceivable, such as at least partially conical coupling elements or those with an undercut that can be bridged by the coupling elements in the unstressed state.

According to the invention, there should be a clearance fit between the opening of the supporting element and the pin of the effector that allows a connection between the supporting element and the effector when the robot picks up the effector, so that the effector on the supporting element remains sufficiently secure for transport purposes during every movement of the robot in free space, not until by actuating the locking mechanism before the opening is then narrowed and the effector is fixed in such a way that forces can also be transmitted via it or the activity intended for the effector can be carried out without the risk of the effector loosening.

The advantage of providing such a clearance fit is that a robot, which, for example, has an integrated compliance control, can join the initially loose connection between opening and pin itself. This is not possible with a fit that is able to hold the effector or the tool element independently right from the start, as is the case with the robot systems described above.

According to an embodiment of the invention, an opening width that is variable by the locking mechanism results from the fact that the opening is enclosed at least partially by two legs of the supporting element that are movable relative to one another, with the legs preferably being of resilient design and these being movable against the spring effect by means of the locking mechanism. The spring effect can be created, for example, by making recesses in the body of the supporting element at appropriate points and with an appropriate shape and dimensioning.

According to the invention, the coupling elements of both the supporting element and the effector can have a complementary cylinder, wedge or cone shape at least in sections. In addition, at least one locking mechanism may be provided between the coupling elements. For example, a spring pin or bolt radially mounted on the cylinder section of the effector is conceivable, which engages in a corresponding radial opening in the receiving opening for the cylinder section of the supporting element and which can be released by a simple translational movement of the coupling element.

In a preferred embodiment, the coupling elements are designed in such a way that a bayonet locking mechanism can be formed between them. This can be achieved, for example, by the robot connecting the supporting element to the effector by a laterally directed translatory movement and then closing the bayonet locking mechanism by a pivoting movement of the supporting element.

In addition to the aforementioned wedge, cylindrical or conical clamping elements or screw connections, another preferred embodiment of the invention is that a lever is pivotably mounted on the outside of the supporting element, which can narrow the opening in the supporting element in the manner of a quick-release.

This embodiment of a locking mechanism allows the lever to be operated in a particularly simple manner by a simple relative movement of the robot relative to the abutment, while contacting the abutment.

In particular, but not exclusively, the inventive effector unit should therefore be used with programmable, multi-axis robots, preferably with lightweight robots that have a corresponding compliance control.

The compliance control is based, for example, on the so-called impedance control, which, in contrast to the admittance control already mentioned, is based on torque control at joint level. Depending on a desired dynamic behavior and taking into account the deviations of an actual position from a defined target position and/or an actual velocity from a target velocity and/or an actual acceleration from a target acceleration, forces or torques are determined which are then mapped via the known kinematics of the robot, which results from the number and arrangement of joints and axes and thus degrees of freedom, to corresponding joint torques which are set via the torque control. The torque sensors integrated in the joints record the one-dimensional torque prevailing at the output of the gearbox of the drive unit located in the joint, which can take the elasticity of the joint into account as a measured variable within the scope of control. In particular, in contrast to the use of only one force moment sensor at the end effector, as in admittance control, the use of appropriate torque sensors also allows the measurement of forces which are not exerted on the end effector but on the links or members of the robot and on an object held by or to be processed by the robot. The torques can also be measured via force sensors in the structure and/or base of the robot system. In particular, joint mechanisms between the individual axes of the manipulator can also be used, which allow multi-axis torque detection. Also conceivable are translatory joints equipped with corresponding force sensors.

The compliance control implemented in this way proves to be advantageous for this invention, since such a robot can trigger or actuate the locking mechanism via a controlled self-motion. In addition, such a robot is able to “search” for the various tool elements or effectors and to “feel” them without damage, which proves to be advantageous for an automatic tool change. In this way, any number of functionally different tool elements, such as the aforementioned gripping contours, which are designed for different purposes and for different objects and tools to be gripped, can be stored in a magazine that is assigned to at least one robot and arranged in its immediate vicinity.

Another advantage of the compliance control is that it allows a coupling between the coupling elements of the supporting element and the effector that is more inaccurate or not precisely positioned, which means that the above-mentioned coupling alternatives can be manufactured with higher tolerances. Inaccuracies caused by this can be compensated by a correspondingly compliant control by a reduction of the contact forces in the coupling. For example, gripping effectors with any contours and undercuts, which can be produced by the additive 3D printing process, can also be used.

In the embodiment with a lever, the externally located abutment serves as a passive actuating element, so to speak, against which the supporting element, which is loosely connected to the effector for the time being, is moved or adjusted by the robot in order to bring the locking mechanism into abutment or into contact with the abutment. The robot then presses the locking mechanism against the abutment with such a force or moves it along with such a controlled movement that the locking mechanism is thereby transferred to the closed position and the effector is clamped to the supporting element or the connection of its coupling elements is blocked.

Using a lever, preferably designed as a quick-clamp, it may be sufficient for the robot to move and press the effector unit against an abutment located in the immediate vicinity of the robot's working area, for example against a table edge of a conveyor working device or against a housing section of a machine with which the robot cooperates.

According to a preferred embodiment, the lever has an outer contour that can be moved continuously along the abutment.

As an abutment, preferably in the immediate area of a magazine for changing with several tool elements, a rotatable rolling element is also conceivable, on which the effector unit can be guided along by means of a controlled swivel or linear movement of the robot while the locking lever is in contact therewith and the lever can thus be pressed towards the supporting element.

Furthermore, it is also conceivable that the external actuating element in the form of an actuator actively influences the locking mechanism. Any type of actuator is conceivable for such actuators, such as pressure plungers, which press the lever against the supporting element after the robot has previously brought the effector unit into a corresponding relative position relative to such an active actuator.

To release the locking mechanism after the intended working step for the effector has been completed and an effector change is pending, it can be brought back to contact with a passive abutment in order to open the locking mechanism via a relative movement of the robot relative to the abutment.

When using a lever, the free end of the lever can be hooked into an edge, whereby the robot's own movement is then programmed and carried out in such a way that the lever is pulled up and the fixed connection between the coupling element of the supporting element and the coupling element of the effector is released. The effector unit can then be fed to an appropriate holding device for changing the effector.

In a preferred embodiment according to the invention, the lever has an engagement opening for the actuator, which in this case is designed as a stationary pin and preferably aligned horizontally. The robot moves the effector unit in such a way that the engagement opening of the lever is pushed over the pin and the lever is pulled up by means of a relative movement of the effector unit relative to the pin.

An essential advantage of the effector unit according to the invention is that an effector or tool change can be carried out automatically in a simple manner, preferably exclusively by the robot's own movement.

The invention therefore also concerns a corresponding working device or station with a robot, with at least one effector and with an effector unit, wherein the effector unit forming a coupling device is designed according to the aforementioned embodiments.

Since the programmed movements of the robot according to the invention allow an effector change to be carried out independently and fully automatically, the working device can also include a holding device for the effector or a magazine for several effectors, whereby the effectors can be movably deposited or picked up by the robot on the holding device.

In a preferred embodiment, a linear guide is formed between the holding device and the tool element or effector, which allows the tool elements to be easily raised and lowered by a linear, vertical up and down movement of the robot. In one design, guide pins are provided on the holding device, preferably freely arrangeable as required, which engage in corresponding holes in the tool elements or effectors.

In order to maintain the relative positional relationship between the tool element and the supporting element when fetching the tool element from the holding device before they are transferred to the abutment for locking, at least one means between the supporting element and the tool element for precise positioning of the tool element on the supporting element is provided. For this purpose, means of any design are conceivable for aligning the position, such as tongue and groove connections, journals, heels, projections and the like.

The position of the holding device and the respective positions of the effector(s) arranged on it, the position of the abutment(s) and the position of the coupling elements of both the effector and the supporting element, in each case also in relation to the position of the robot, determine the motion sequences to be performed by the robot and their accuracy. All these parameters must be taken into account in a coordinate system assigned to the robot, the selection of the type of coordinates (e.g. Cartesian, cylindrical, spherical coordinates) being determined by the desired behaviour of the robot in the task space provided for this purpose, which is based on a corresponding compliance control, which is why robots with such an integrated compliance control, in particular lightweight robots, are particularly suitable for the use of an effector unit and a working device according to the invention.

In this context, the invention therefore also concerns a method, preferably performed by a robot with integrated compliance control, with intrinsic compliance or with a combination of active and passive compliance, for changing an effector at an end member of such a robot, a supporting element being provided at the end member of the robot, with which the effector can be fastened by means of positive and/or non-positive coupling elements engaging into one another and can be releasably and losslessly connected by means of a locking mechanism, the supporting element being movable relative to the end member and the coupling elements being connectable in a common axial alignment which is arranged parallel to the direction of movement of the supporting element, comprising the steps of:
picking up the effector from a holding device by connecting the coupling element of the supporting element to the coupling element of the effector by means of a first sequence of robot movements to form an effector unit;
transferring the effector unit to an abutment by means of a second sequence of robot movements; and
moving the locking mechanism relative to the abutment with locking of the supporting element and the effector by means of a third sequence of robot movements.

After completion of the effector operation, e.g. on a conveyor belt or a conveyor processing device, along which the robot can move the objects independently for processing purposes, the following further steps can follow:
transferring the effector unit to one or another abutment by means of a fourth sequence of robot movements;
moving the locking mechanism with respect to the abutment by unlocking the supporting member and the effector by means of a fifth sequence of robot movements; and
placing the effector on the holding device by decoupling the coupling element of the supporting element from the coupling element of the effector by means of a sixth sequence of robot movements.

If a magazine with several tool elements or effectors is used, which all have a universal interface to the supporting element, since they have the same type of coupling elements, the inventive method is further characterized by the fact that the aforementioned steps of the individual sequences of robot movements can be repeated sequentially using several different tool elements or effectors.

Further advantages and features of the invention result from the embodiment explained below with reference to the enclosed illustrations.

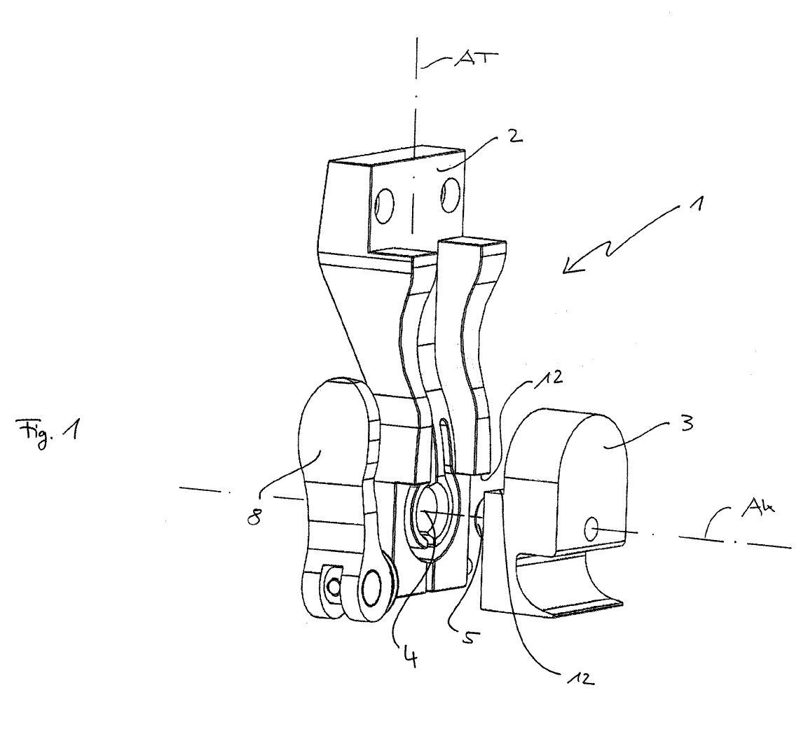

FIG. 1 is a perspective view of a first embodiment of an effector unit according to the invention, in which the supporting element is separated from the effector;

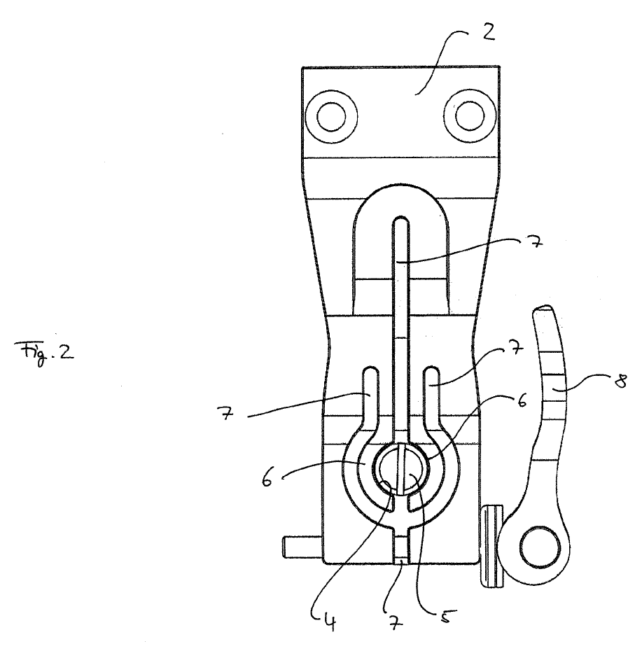

FIG. 2 is a view from the rear of the supporting element of this effector unit;

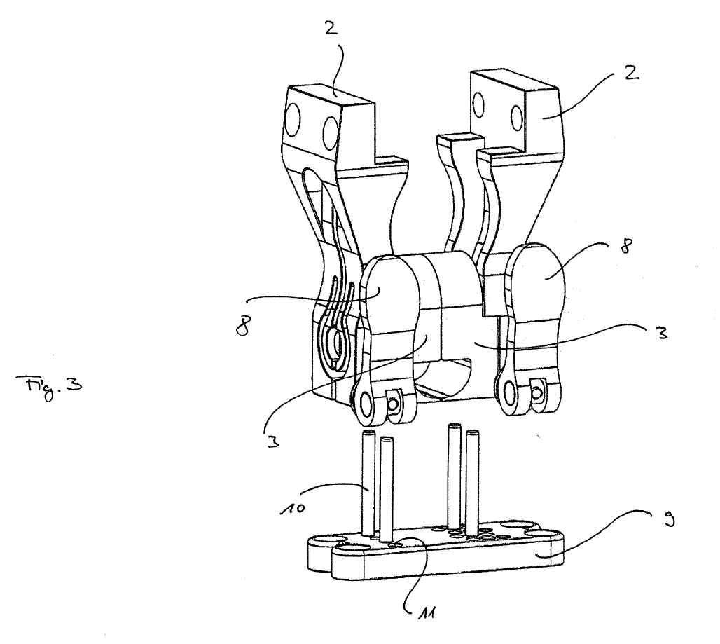

FIG. 3 is a perspective view of a working device according to the invention with two effector units of the first embodiment;

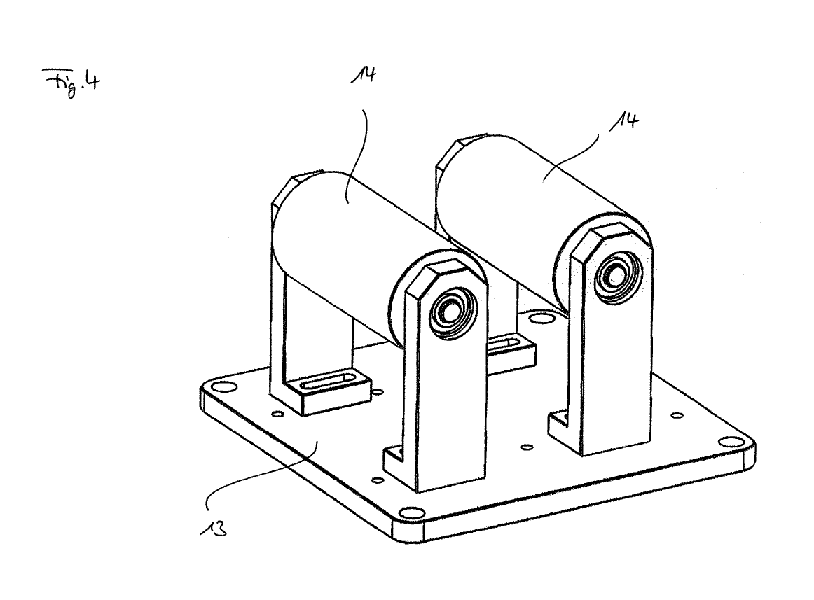

FIG. 4 shows an abutment according to the invention with rolling elements;

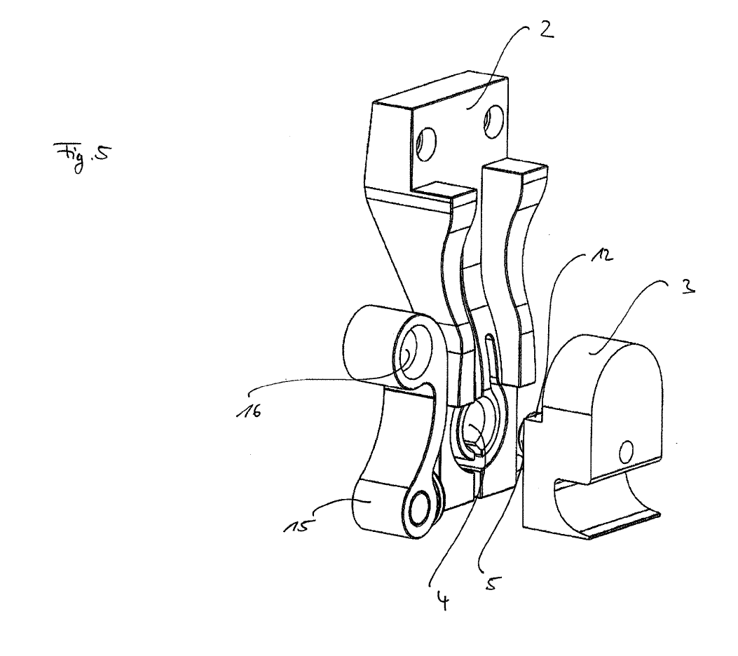

FIG. 5 is a perspective view of a second effector unit according to the invention, in which the supporting element is separated from the effector;

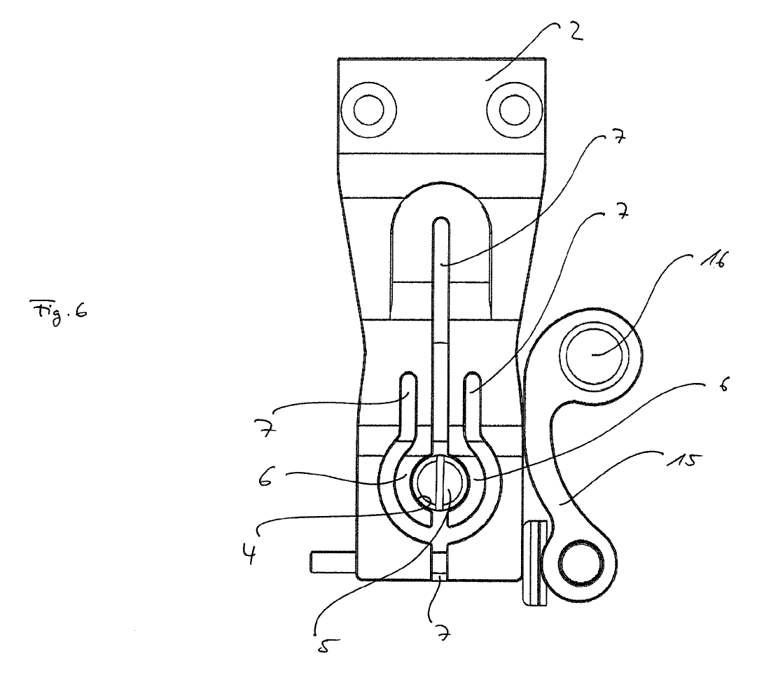

FIG. 6 is a view from the rear of the supporting element of this effector unit;

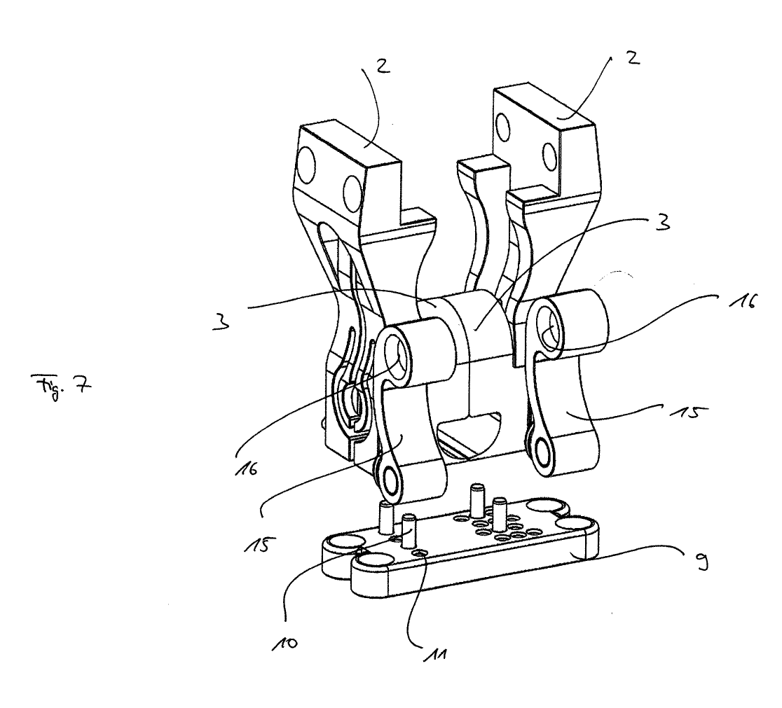

FIG. 7 is a perspective view of a working device according to the invention with two effector units of the second embodiment; and

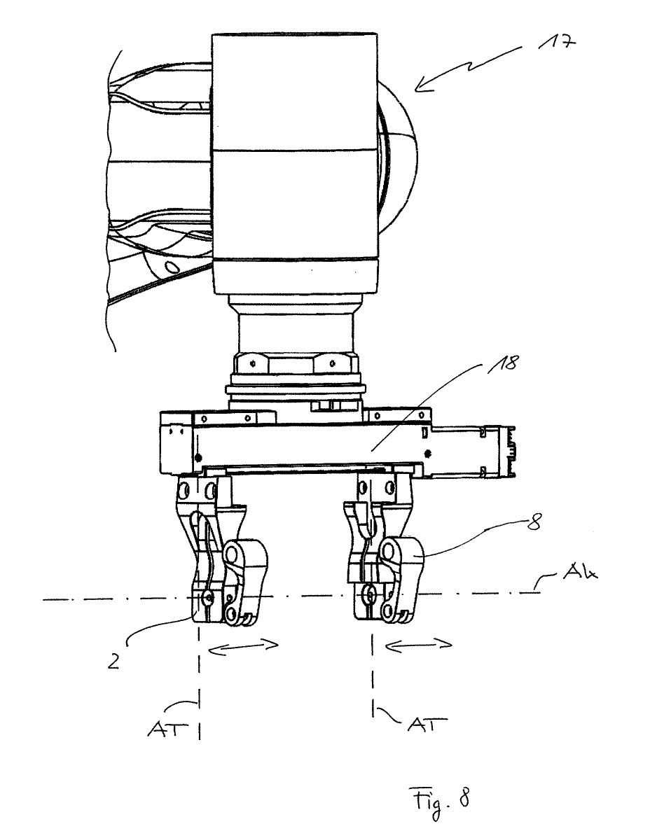

FIG. 8 is a schematic representation in which effector units are arranged at one end member of a robot.

FIGS. 1 to 4 show a first embodiment of an effector unit according to the invention.

FIG. 1 shows an effector unit 1 in a non-assembled state, which is formed by a supporting or retaining element 2 and an effector 3, in this case a gripper jaw.

Supporting element 2 is used to be fastened to an end link or member 17 of a robot, as can be seen in FIG. 8.

As this FIG. 8 shows, two opposite effector units 1 form a gripping mechanism. For that, two supporting elements 2 can be moved relative to each other via a corresponding actuating mechanism 18 and thus relative to the end link 17 of the robot, which is symbolized by the arrows.

The supporting element 2 and the gripper jaw 3 can be connected via coupling elements. For this purpose, supporting element 2 has a coupling element in the form of a substantially circular opening 4, as can be seen in FIG. 2, whereby a coupling element of the gripper jaw 3 with a correspondingly complementary shape, a cylindrical pin 5, can engage into opening 4.

The coupling elements 4 and 5 are aligned in a common axis AK, which runs transversely to the orientation AT of the longitudinal extension of the supporting element 2, as shown schematically in FIG. 1 and FIG. 8. The common axial alignment AK of the coupling elements 4.5 is oriented parallel to the linear direction of movement of the supporting elements 2 (see arrows in FIG. 8).

Several, possibly functionally different effectors have identical coupling elements 5, so that a universal coupling mechanism is made available in conjunction with supporting element 2, which allows an easy effector change. The pin 5 and the effector 3 can preferably be made in one piece.

As can be seen from FIG. 2, opening 4 is enclosed by two legs 6, which are formed by cut-outs or recesses 7 in the body of the supporting element 2. The recesses 7 are designed and dimensioned in such a way that the opening width of opening 4 is variable and the legs 6 can exert a spring effect relative to each other.

A locking mechanism in the form of a pivotally mounted lever 8 is arranged on the side of supporting element 2, which realises a quick-release lock in the area of the free ends of supporting element 2.

By actuating lever 8, the legs 6 are moved towards each other, contrary to the spring effect and thus clamp the pin 5 of the effector 3 in the opening 4.

Effectors 3 are placed and stored on a holding device 9 of a working station according to the invention, as FIG. 3 illustrates.

The holding device 9 has vertical pins 10, the position of which can be individually adjusted via various holes 11. The pins 10 engage in corresponding (not shown) holes on the underside of the effectors 3 with a sliding fit to allow a linear, vertical guidance of the effectors 3.

In a special embodiment according to the invention, the effector units 1 are to be used by a robot which has an integrated compliance control and which motion sequences can be programmed individually, e.g. under consideration of the impedance control.

Changing an effector 3 can therefore be done as follows. The robot moves the supporting element 2 or two opposing supporting elements 2 to the holding device 9, whereby it then moves laterally to the effector 3 in such a way that the pin 5 is received by the opening 4 of the supporting element 2, which together form a universal coupling. This creates the effector unit 1, since the tolerances between the opening 4 and the pin 5 allow easy pick-up on the one hand and at the same time sufficient hold of the effector 3 on the supporting element 2 for transport purposes on the other.

The effector unit 1 is then lifted vertically by simply pulling it off the pins 10 of the holding device 9.

In order to ensure an exact positioning between the two elements during the connection of supporting element 2 and effector 3, positioning means are provided on both elements, here in the form of adjacent steps 12, so that an incorrect adjustment of the gripper jaw 3 is excluded.

After lifting the effector unit 1, the robot moves it to a stationary abutment 13, as can be seen in FIG. 4.

The abutment 13 has rollers or rolling elements 14. The rolling elements 14 form a passive actuation which closes the intended quick release mechanism by inserting the levers 8 linearly between the rolling elements 14. Lever 8 has such a contour that during the insertion movement of the effector unit 1, the rolling elements 14 simply roll along lever 8, thus significantly increasing the closing force on lever 8 and thus via the quick clamping mechanism on opening 4 compared to the force applied in the direction of the linear insertion movement. Therefore, the robot does not have to move sideways and generate a corresponding force. The programming effort is kept simple, since only a linear movement has to be carried out by the robot.

Alternatively, however, it is also possible for the robot to close the lever 8 in a simple manner by engaging any surface by means of a corresponding movement, force control and/or force pre-control.

If this means that the pin 5 of the effector 3 is tensed in the opening 4 of the supporting element 2 without becoming loose, the effector unit 1 can be used for its functional determination.

The lever 8 is also designed in such a way that it can be closed manually by a user if necessary. Active actuators are also conceivable, such as pneumatically or hydraulically activated plungers, which engage the lever 8 and deflect it into the closed position.

When the locking mechanism is released, the above steps are basically performed in reverse order. However, the robot can move to another (not shown) abutment and attach it with the free end of lever 8, for example at one edge, and pull up lever 8 in a simple way by a corresponding movement directed away from the abutment.

FIGS. 5 to 7 show a second embodiment of the effector unit 1 according to the invention, which in principle is functionally identical, with the difference that a lever 15 is provided, which has a different contour profile.

Lever 15 can also be used to lock the locking mechanism on an abutment 13.

For opening the lever 15 has a continuous engagement opening 16 at its free end. For this purpose, the robot can go through a programmed movement sequence in which it pushes the effector unit 1 laterally onto a (not shown) stationary pin or rod aligned in a preferably horizontal direction with engagement in the engagement opening 16, and moves the effector unit 1 away from this pin, whereby the lever 15 is opened.

FIG. 8 schematically shows the arrangement of two effector units 1 at one end link 17 of the robot, which form a gripping mechanism.

In order to carry out the tool change in the above-mentioned embodiment, it is intended that the coupling elements of supporting element 2 and the coupling elements of the effector 3, irrespective of their design, lie in a common axial alignment AK, which is shown schematically in FIG. 8. According to the invention this alignment AK of the coupling elements is arranged transversely to the orientation AT of the supporting element 2, which is also shown schematically in FIG. 8, and corresponds to the direction of movement of the supporting elements 2 (see arrows), thus also to the direction of the gripping and holding force to be applied by the gripper jaws 3 for the objects to be gripped.

1. Effector unit for a robot having at least one supporting element arranged at an end member of the robot, having an effector which can be fastened to the supporting element by means of coupling elements engaging into one another in a form-fit and/or force-fit manner, and having a locking mechanism which connects a coupling element of the effector to a coupling element of the supporting element in a detachable and loss-proof manner,
wherein the supporting element is movably arranged relative to the end member, and in that the coupling elements can be connected in a common axial alignment which is arranged parallel to the direction of movement of the supporting element.

2. Effector unit according to claim 1, in which the coupling elements are designed to be connected or decoupled by a rotational and/or translational displacement movement of the robot.

3. Effector unit according to claim 1, in which the locking mechanism is arranged on the supporting element in such a free accessible way that it can be actuated actively or passively by an external actuating element.

4. Effector unit according to claim 3, in which the locking mechanism is designed such that it can be actuated under contact with an abutment by a displacement movement of the robot.

5. Effector unit according to claim 4, in which the locking mechanism is designed such that it can be actuated by a displacement movement of the robot under a releasable engagement with an abutment.

6. Effector unit according to claim 1, in which the coupling element of the supporting element is formed as an opening for receiving the coupling element of the effector with an opening width to be varied by the locking mechanism.

7. Effector unit according to claim 6, in which the opening is at least partially enclosed by two legs of the supporting element, which are moveable relative to each other.

8. Effector unit according to claim 7, in which the legs are designed to exert a mutual spring action, the legs being movable against the spring action by means of the locking mechanism.

9. Effector unit according to claim 8, in which the spring effect can be produced by recesses in the supporting element.

10. Effector unit according to claim 1, in which the coupling elements have a complementary cylinder, wedge or cone shape at least in sections.

11. Effector unit according to claim 1, in which at least one detent mechanism is provided between the coupling elements.

12. Effector unit according to claim 11, in which the coupling elements are formed as a bayonet locking mechanism.

13. Effector unit according to claim 1, in which the coupling elements are formed as a screw connection.

14. Effector unit according to claim 3, in which the locking mechanism is formed as a lever pivotably mounted on the supporting element.

15. Effector unit according to claim 14, in which the lever has a contour which can be moved continuously along an abutment.

16. Effector unit according to claim 14, in which the lever has an engagement opening for the actuating element.

17. Effector unit according to claim 1, in which at least one means is provided between the supporting element and the effector for precisely positioning the effector during the coupling process.

18. Robot comprising an effector unit according to any claim 1.

19. Working device with a robot, at least one effector and an effector unit, wherein the effector unit is designed according to claim 1.

20. Working device according to claim 19, in which a holding device for the effector is provided, on which the effector can be movably deposited.

21. Working device according to claim 20, in which a linear guide is formed between the holding device and the effector.

22. Working device according to claim 19, in which an abutment is provided which interacts with the effector unit during a displacement movement of the robot.

23. Working device according to claim 22, in which the abutment is formed at least partially complementary in shape to the locking mechanism of the effector unit.

24. Working device according to claim 23, in which the abutment is constructed as at least one rolling element.

25. Method for changing an effector on an end member of a robot, wherein a supporting element is provided on the end member of the robot, with which the effector can be fastened by means coupling elements in a form-fit and/or force-fit manner, which are releasably and captively connectable by means of a locking mechanism, wherein the supporting element is movable relative to the end member, and wherein the coupling elements are connectable in a common axial alignment which is arranged parallel to the direction of movement of the supporting element,
comprising the steps of:
picking up the effector from a holding device by connecting the coupling element of the supporting element to the coupling element of the effector by means of a first sequence of robot movements to form an effector unit;
transferring the effector unit to an abutment by means of a second sequence of robot movements; and
moving the locking mechanism with respect to the abutment while locking the supporting element and the effector of the effector unit by means of a third sequence of robot movements.

26. Method according to claim 25, after completion of the activity intended for the effector, further comprising the steps:
transferring the effector unit to the or a further abutment by means of a fourth sequence of robot movements;
moving the locking mechanism with respect to the abutment by unlocking the supporting member and the effector of the effector unit by means of a fifth sequence of robot movements; and
placing the effector on the holding device by decoupling the coupling element of the supporting element from the coupling element of the effector by means of a sixth movement of robot movements.

27. Method according to claim 25, in which the steps of the individual sequences of the robot movements are sequentially repeatable using a plurality of different effectors.
